(19) United States
(12) Patent Application Publication
(10) Pub. No.: US 2026/0275132 A1
(43) Pub. Date: Sep. 17, 2026

(54) INK AND INKJET RECORDING METHOD

(71) Applicants: Ayaka MATSUMOTO, Kanagawa (JP); Yuta NAKAMURA, Tokyo (JP); Hiroshi GOTOU, Shizuoka (JP); Shunsuke HORIE, Kanagawa (JP)

(72) Inventors: Ayaka MATSUMOTO, Kanagawa (JP); Yuta NAKAMURA, Tokyo (JP); Hiroshi GOTOU, Shizuoka (JP); Shunsuke HORIE, Kanagawa (JP)

(21) Appl. No.: 19/560,224

(22) Filed: Mar. 9, 2026

(30) Foreign Application Priority Data
Mar. 12, 2025 (JP) 2025-039668

(51) Int. Cl. C09D 11/30; B41M 7/00; C09D 11/107

(52) U.S. Cl. CPC C09D 11/30; B41M 7/009; C09D 11/107

(57) ABSTRACT

An ink including a pigment, a resin, an organic solvent, and water is provided. The resin includes an acrylic resin. The organic solvent includes an organic solvent A having a boiling point of 120° C. or higher and 170° C. or lower and an organic solvent B having a boiling point of 180° C. or higher and 210° C. or lower. A solubility parameter value of the organic solvent B is greater than that of the organic solvent A, a content of the organic solvent A is 0.6 times or more and 2 times or less that of the organic solvent B, a contact angle of the organic solvent A on a dried film of the ink is less than that of the organic solvent B, and a difference therebetween at 1000 ms is 5° or more.

### CROSS-REFERENCE TO RELATED APPLICATIONS

This patent application is based on and claims priority pursuant to 35 U.S.C. § 119(a) to Japanese Patent Application No. 2025-039668, filed on Mar. 12, 2025, in the Japan Patent Office, the entire disclosure of which is hereby incorporated by reference herein.

### BACKGROUND

### Technical Field

The present disclosure relates to an ink and an inkjet recording method.

### Related Art

The inkjet recording method is a recording method in which a small amount of ink droplets is ejected from fine nozzles and deposited onto a recording medium such as paper to form characters and images. Because this method produces low noise, has a simple process, allows easy color printing, and offers low running costs, it has rapidly become widespread. In recent years, the inkjet recording method has also been expanding into commercial printing applications because of its advantages such as variable printing capability and compatibility with a wide range of media.

For example, in recording media having a coated layer, such as coated paper used for commercial printing or publishing, the media are not designed to absorb a large amount of ink in a short time as inkjet-dedicated paper is. As a result, the absorption of the ink cannot keep up, leading to poor drying properties and causing problems such as ink transfer onto conveyance rollers.

### SUMMARY

The present disclosure described herein provides an ink including a pigment, a resin, an organic solvent, and water. The resin includes an acrylic resin. The organic solvent includes an organic solvent A having a boiling point of 120° C. or higher and 170° C. or lower and an organic solvent B having a boiling point of 180° C. or higher and 210° C. or lower. A solubility parameter value of the organic solvent B is greater than that of the organic solvent A, a content of the organic solvent A is 0.6 times or more and 2 times or less that of the organic solvent B, a contact angle of the organic solvent A on a dried film of the ink is less than that of the organic solvent B, and a difference therebetween at 1000 ms is 5° or more.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective explanatory view of a recording apparatus using an ink according to an embodiment of the present invention; and

FIG. 2 is a perspective explanatory view of a main tank containing an ink according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to embodiments of the present invention, an ink is provided that exhibits excellent drying properties and fixability not only on plain paper but also on commercial printing paper, and that also has good storage stability and ejection stability.

### (Ink)

Hereinafter, an organic solvent, water, a colorant, a resin, an additive, and other components used in the ink are described.

### <Organic Solvent>

The ink according to an embodiment of the present invention includes two or more organic solvents (i.e., an organic solvent A and an organic solvent B). The organic solvent A has a boiling point of 120° C. or higher and 170° C. or lower. By including the low-boiling organic solvent A, an ink having good drying properties can be obtained. The organic solvent B has a boiling point of 180° C. or higher and 210° C. or lower. By including the organic solvent B having a higher boiling point than the organic solvent A, the solvent functions as a humectant.

By including two or more organic solvents having different boiling points, an ink can be obtained that exhibits high drying properties and excellent productivity (i.e., fixability) even on commercial printing paper, while also having good ejection stability.

As the organic solvent A, a water-soluble organic solvent having a boiling point of 120° C. or higher and 170° C. or lower can be used. As the organic solvent B, a water-soluble organic solvent having a boiling point of 180° C. or higher and 210° C. or lower can be used.

Examples of the water-soluble organic solvent include, but are not limited to, a polyhydric alcohol, an ether such as a polyhydric alcohol alkyl ether or a polyhydric alcohol aryl ether, a nitrogen-containing heterocyclic compound, an amide, an amine, and a sulfur-containing compound.

Specific examples of the organic solvent A include, but are not limited to, a polyhydric alcohol alkyl ether such as ethylene glycol monoethyl ether, ethylene glycol monobutyl ether, or propylene glycol monoethyl ether, a polyhydric alcohol aryl ether such as ethylene glycol monophenyl ether, an amide such as N,N-dimethylformamide, an amine such as monoethanolamine, and a sulfur-containing compound such as dimethyl sulfoxide.

A glycol ether compound is also preferably used. Specific examples of the glycol ether compound include, but are not limited to, ethylene glycol monomethyl ether, ethylene glycol monomethyl ether acetate, ethylene glycol mono-iso-propyl ether, ethylene glycol mono-t-butyl ether 152, propylene glycol monomethyl ether, propylene glycol monoethyl ether, propylene glycol monobutyl ether, propylene glycol mono-t-butyl ether, and propylene glycol mono-n-propyl ether.

Of these, a glycol ether-based solvent is preferable as the organic solvent A from the viewpoints of drying properties and fixability.

Specific examples of the organic solvent B include, but are not limited to, a polyhydric alcohol such as ethylene glycol, 1,2-propanediol, 1,2-butanediol, 1,3-butanediol, 2,3-butanediol, 3-methyl-1,3-butanediol, 1,2-pentanediol, or 2,4-pentanediol, a polyhydric alcohol alkyl ether such as diethylene glycol monomethyl ether or diethylene glycol monoethyl ether, a nitrogen-containing heterocyclic compound such as N-methyl-2-pyrrolidone or γ-butyrolactone, an amide such as formamide or N-methylformamide, and a sulfur-containing compound such as dimethyl sulfoxide.

A glycol ether compound is also preferably used. Specific examples of the glycol ether compounds include, but are not limited to, a polyhydric alcohol alkyl ether such as diethylene glycol mono-iso-propyl ether, dipropylene glycol monomethyl ether, or dipropylene glycol mono-n-propyl ether, which is a type of a glycol ether, and a polyhydric alcohol aryl ether such as ethylene glycol monophenyl ether or ethylene glycol monobenzyl ether.

Of these, an alkanediol-based solvent is preferable as the organic solvent B from the viewpoints of fixability and ejection reliability.

A polyol compound having eight or more carbon atoms and a glycol ether compound can improve the penetrability of the ink when paper is used as the recording medium.

In the ink according to an embodiment of the present invention, the organic solvent A and the organic solvent B are selected such that a solubility parameter value (“SP value”) of the organic solvent B is greater than that of the organic solvent A. By including the organic solvent A having a low SP value and a low boiling point, excellent drying properties are achieved, and plasticization of the resin, which may cause blocking, does not occur. The organic solvent having not only a low boiling point and high volatility but also a low SP value can improve the ink penetrability when paper is used as the recording medium, thereby providing a printed matter with better fixability. Further, by including the organic solvent B having a high SP value and a high boiling point, plasticization of the resin is less likely to occur, and an ink with excellent ejection stability can be obtained.

Note that the SP value can be calculated by the following formula using the Fedors method described in R. F. Fedors: Polym. Eng. Sci., 14 [2], 147-154 (1974).

$$δ = {( {E}_{v} / V )}^{1 / 2} = {( Δ ei / Δ vi )}^{1 / 2}$$

Here, δ represents the SP value, Eᵥ represents the evaporation energy, V represents the molar volume, Δei represents the evaporation energy of an atom or atomic group of the component, and Δvi represents the molar volume of an atom or atomic group of the component.

From the viewpoint of drying properties, the content of the organic solvent A is 0.6 times or more the content of the organic solvent B, and from the viewpoint of ejection reliability, it is 2 times or less the content of the organic solvent B.

The total content of the organic solvent A and the organic solvent B is not particularly limited and can be appropriately selected depending on the purpose. However, from the viewpoints of drying properties and ejection reliability of the ink, the total content is preferably 10% by mass or more and 60% by mass or less, more preferably 20% by mass or more and 40% by mass or less.

### <Water>

The water content in the ink is not particularly limited and can be appropriately selected depending on the purpose. However, from the viewpoints of drying properties and ejection reliability of the ink, the water content is preferably 10% by mass or more and 90% by mass or less, more preferably 20% by mass or more and 60% by mass or less.

### <Colorant>

The colorant is not particularly limited, and a pigment or a dye can be used.

As the pigment, an inorganic pigment or an organic pigment can be used. These may be used alone or in combination of two or more types. Further, a mixed crystal may also be used.

Examples of the pigment that can be used include, but are not limited to, a black pigment, a yellow pigment, a magenta pigment, a cyan pigment, a white pigment, a green pigment, an orange pigment, and a glossy or metallic pigment such as a gold or silver pigment. Examples of the inorganic pigment that can be used include titanium oxide, iron oxide, calcium carbonate, barium sulfate, aluminum hydroxide, barium yellow, cadmium red, and chrome yellow, as well as carbon black produced by a known method such as the contact method, the furnace method, or the thermal method.

Further, examples of the organic pigment that can be used include, but are not limited to, an azo pigment, a polycyclic pigment (e.g., a phthalocyanine pigment, a perylene pigment, a perinone pigment, an anthraquinone pigment, a quinacridone pigment, a dioxazine pigment, an indigo pigment, a thioindigo pigment, an isoindolinone pigment, a quinophthalone pigment, etc.), a dye chelate (e.g., a basic dye type chelate, an acid dye type chelate, etc.), a nitro pigment, a nitroso pigment, and aniline black. Among these pigments, those having good affinity with the solvent are preferably used. In addition, resin hollow particles and inorganic hollow particles can also be used.

Specific examples of the pigment for black include carbon black (C.I. Pigment Black 7) such as furnace black, lamp black, acetylene black, or channel black, a metal-based pigment such as copper, iron (C.I. Pigment Black 11), or titanium oxide, and an organic pigment such as aniline black (C.I. Pigment Black 1).

Further, examples of the pigment for color include, but are not limited to, C.I. Pigment Yellow 1, 3, 12, 13, 14, 17, 24, 34, 35, 37, 42 (iron oxide yellow), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 4, 5, 17, 22, 23, 31, 38, 48:2, 48:3, 48:4, 49:1, 52:2, 53:1, 57:1 (Brilliant Carmine 6B), 60:1, 63:1, 63:2, 64:1, 81, 83, 88, 101 (Red Iron Oxide), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4 (Phthalocyanine Blue), 16, 17:1, 56, 60, and 63; and C.I. Pigment Green 1, 4, 7, 8, 10, 17, 18, and 36.

The dye is not particularly limited, and an acid dye, a direct dye, a reactive dye, and a basic dye can be used. These may be used alone or in combination of two or more types.

Examples of the dye include C.I. Acid Yellow 17, 23, 42, 44, 79, and 142; C.I. Acid Red 52, 80, 82, 249, 254, and 289; C.I. Acid Blue 9, 45, and 249; C.I. Acid Black 1, 2, 24, and 94; C.I. Food Black 1 and 2; C.I. Direct Yellow 1, 12, 24, 33, 50, 55, 58, 86, 132, 142, 144, and 173; C.I. Direct Red 1, 4, 9, 80, 81, 225, and 227; C.I. Direct Blue 1, 2, 15, 71, 86, 87, 98, 165, 199, and 202; C.I. Direct Black 19, 38, 51, 71, 154, 168, 171, and 195; C.I. Reactive Red 14, 32, 55, 79, and 249; and C.I. Reactive Black 3, 4, and 35.

From the viewpoints of improving image density and achieving good fixability and ejection stability, the content of the colorant in the ink is preferably 0.1% by mass or more and 15% by mass or less, more preferably 1% by mass or more and 10% by mass or less.

To obtain the ink by dispersing the pigment, a method such as introducing hydrophilic functional groups into the pigment to make it a self-dispersible pigment, coating the surface of the pigment with a resin to disperse it, or dispersing the pigment using a dispersant can be mentioned.

Examples of the method for rendering the pigment self-dispersible by introducing hydrophilic functional groups include a method in which functional groups such as a sulfonic group and a carboxyl group are added to the pigment (e.g., carbon) to make it dispersible in water.

Examples of the method for dispersing the pigment by coating its surface with a resin include a method in which the pigment is encapsulated in microcapsules to make it dispersible in water. The pigment dispersed by coating its surface with a resin can also be referred to as a resin-coated pigment. When the pigment surface is coated with a resin for dispersion, it is not necessary for all of the pigments included in the ink to be coated with resin, and uncoated or partially coated pigments may be present in the ink as long as the effects of the present invention are not impaired.

Examples of the method for dispersing the pigment using a dispersant include a method in which a known low molecular weight dispersant or a known high molecular weight dispersant, represented by a surfactant, is used for dispersion.

As the dispersant, for example, an anionic surfactant, a cationic surfactant, an amphoteric surfactant, a nonionic surfactant, or the like can be used depending on the pigment.

PIONIN RT-100 (nonionic surfactant) manufactured by Takemoto Oil & Fat Co., Ltd. or sodium naphthalenesulfonate formalin condensate can be preferably used as the dispersant.

The dispersant may be used alone or in combination of two or more types.

### <Pigment Dispersion>

The ink can be obtained by mixing the pigment with a material such as water or an organic solvent. Alternatively, the ink can be produced by first preparing a pigment dispersion by mixing the pigment with other components such as water and a dispersant, and then mixing the pigment dispersion with a material such as water or an organic solvent.

The pigment dispersion can be obtained by mixing and dispersing water, a pigment, a pigment dispersant, and, if necessary, other components, followed by adjusting the particle size. It is preferable to perform the dispersion using a dispersing machine.

The particle size of the pigment in the pigment dispersion is not particularly limited. However, from the standpoints of achieving good dispersion stability of the pigment and improving ejection stability and image quality such as image density, the maximum frequency particle size of the pigment, expressed in terms of the number of particles, is preferably 20 nm or more and 500 nm or less, more preferably 20 nm or more and 150 nm or less. The particle size of the pigment can be measured using a particle size analyzer (Nanotrac Wave II-UT151, manufactured by MicrotracBEL Corp.).

The content of the pigment in the pigment dispersion is not particularly limited and can be appropriately selected depending on the purpose. However, from the viewpoints of obtaining good ejection stability and improving image density, the pigment content is preferably 0.1% by mass or more and 50% by mass or less, more preferably 0.1% by mass or more and 30% by mass or less.

It is preferable, as necessary, to remove coarse particles of the pigment dispersion using a filter, a centrifuge, or the like and to perform degassing.

### <Resin>

The resin included in the ink has excellent film-forming properties (i.e., image forming properties), as well as high solvent resistance, high water resistance, and high weather resistance. The resin having high solvent resistance is less likely to swell in a solvent added to the ink, thereby providing good fixability. This contributes to the formation of an image with high water resistance and high image density (i.e., high color development).

The resin according to an embodiment of the present invention includes an acrylic resin, and preferably further includes a urethane resin.

Resin particles composed of these resins may also be used. The ink can be obtained by mixing the resin particles, in the form of a resin emulsion in which the resin is dispersed in water as a dispersion medium, with a material such as a colorant or an organic solvent. The resin particles to be used may be those appropriately synthesized or commercially available products.

Further, the resin is not particularly limited as long as it has water dispersibility and can be appropriately selected depending on the purpose. However, from the viewpoint of preventing adhesion to a general inkjet head (a nozzle plate with a water-repellent film), it is preferable that the resin is an anionic resin having an anionic functional group such as a carboxyl group, a sulfonic group, or a hydroxyl group.

When the ink according to an embodiment of the present invention is used for image formation in combination with a pre-treatment liquid described below, it is preferable that at least one of the resin and the colorant described below is anionic. When at least one of the resin and the colorant described below is anionic, the ink can be coagulated or thickened when the ink comes into contact with the pre-treatment liquid containing a coagulating agent or the like, which is preferable because it can improve the adhesion of the ink on the surface of a recording medium.

The shape of the resin is not particularly limited and can be appropriately selected depending on the purpose. The resin may have a regular or irregular shape. Of these, a regular shape is preferable.

When the resin has a regular shape, it is preferably spherical. When the resin has a spherical shape, it is preferably in the form of particles.

The volume-average particle diameter of the resin particles is not particularly limited and can be appropriately selected depending on the purpose. However, from the viewpoints of achieving good fixability and high image hardness, the diameter is preferably 10 nm or more and 1,000 nm or less, more preferably 10 nm or more and 200 nm or less, particularly preferably 10 nm or more and 100 nm or less.

The volume-average particle diameter can be measured using, for example, a particle size analyzer (Nanotrac Wave II-UT151, manufactured by MicrotracBEL Corp.).

The content of the resin is not particularly limited and can be appropriately selected depending on the purpose. However, from the viewpoints of fixability and storage stability of the ink, the resin content is preferably 1% by mass or more and 30% by mass or less, more preferably 5% by mass or more and 15% by mass or less, relative to the total amount of the ink.

Further, from the viewpoints of drying properties and fastness properties, the content of the urethane resin is preferably 0.05 times or more and 0.5 times or less the content of the acrylic resin.

Regarding the content of the pigment and the resin, the total amount of the resin is preferably greater than the total amount of the pigment. This makes it less likely for the pigment to be exposed on the surface of the substrate, thereby improving fastness properties such as rubbing resistance.

The acrylic resin and the urethane resin used as the resin are described below.

First, examples of commercially available acrylic resins include the following.
TOCRYL BCX-8111 (Tg: −30° C.; manufactured by artience Co., Ltd.)
TOCRYL W-168 (Tg: −10° C.; manufactured by artience Co., Ltd.)
TOCRYL X-4403 (Tg: −7° C.; manufactured by artience Co., Ltd.)
TOCRYL W-3080 (Tg: 70° C.; volume-average particle diameter: 100 nm; manufactured by artience Co., Ltd.)
HIROS-X PE-2109 (Tg: −10° C.; volume-average particle diameter: 100 nm; manufactured by Chemipaz Corp.)
HIROS-X TE-1336 (Tg: −34° C.; volume-average particle diameter: 150 nm; manufactured by Chemipaz Corp.)
HIROS-X JE-1113 (Tg: −24° C.; volume-average particle diameter: 60 nm; manufactured by Chemipaz Corp.)
HIROS-X RE-2108 (Tg: −37° C.; volume-average particle diameter: 80 nm; manufactured by Chemipaz Corp.)
HIROS-X KE-1062 (Tg: 96° C.; volume-average particle diameter: 80 nm; manufactured by Chemipaz Corp.)
HIROS-X NE-2270 (Tg: 73° C.; volume-average particle diameter: 160 nm; manufactured by Chemipaz Corp.)
HIROS-X JE-1056 (Tg: 82° C.; volume-average particle diameter: 50 nm; manufactured by Chemipaz Corp.)
HIROS-X QE-1042 (Tg: 53° C.; volume-average particle diameter: 40 nm; manufactured by Chemipaz Corp.)

It should be noted that TOCRYL and HIROS are registered trademarks.

Next, examples of commercially available urethane resins include the following.
U-COAT UX-300 (Tg: −25° C.; volume-average particle diameter: 120 nm; manufactured by Sanyo Chemical Industries, Ltd.)
U-COAT UX-310 (Tg: −25° C.; volume-average particle diameter: 120 nm; manufactured by Sanyo Chemical Industries, Ltd.)
U-COAT UX-340 (Tg: −50° C.; volume-average particle diameter: 50 nm; manufactured by Sanyo Chemical Industries, Ltd.)
PERMARIN UA-150 (Tg: −70° C.; volume-average particle diameter: 70 nm; manufactured by Sanyo Chemical Industries, Ltd.)
PERMARIN UA-200 (Tg: −35° C.; volume-average particle diameter: 70 nm; manufactured by Sanyo Chemical Industries, Ltd.)
PERMARIN UA-350 (Tg: −30° C.; volume-average particle diameter: 70 nm; manufactured by Sanyo Chemical Industries, Ltd.)
PERMARIN UA-368 (Tg: −20° C.; volume-average particle diameter: 300 nm; manufactured by Sanyo Chemical Industries, Ltd.)
U-COAT UWS-145 (Tg: −45° C.; volume-average particle diameter: 20 nm; manufactured by Sanyo Chemical Industries, Ltd.)
UPRENE UXA-307 (Tg: −45° C.; volume-average particle diameter: 200 nm; manufactured by Sanyo Chemical Industries, Ltd.)
SUPERFLEX 300 (Tg: −42° C.; volume-average particle diameter: 70 nm; solid content: 30% by mass; manufactured by DKS Co. Ltd.)
SUPERFLEX 420 (Tg: −10° C.; volume-average particle diameter: 10 nm; solid content: 32% by mass; manufactured by DKS Co. Ltd.)
SUPERFLEX 420NS (Tg: −10° C.; volume-average particle diameter: 10 nm; manufactured by DKS Co. Ltd.)
SUPERFLEX 460 (Tg: −21° C.; volume-average particle diameter: 40 nm; solid content: 38% by mass; manufactured by DKS Co. Ltd.)
SUPERFLEX 460S (Tg: −28° C.; volume-average particle diameter: 30 nm; manufactured by DKS Co. Ltd.)
SUPERFLEX 470 (Tg: −31° C.; volume-average particle diameter: 50 nm; solid content: 38% by mass; manufactured by DKS Co. Ltd.)
SUPERFLEX 500M (Tg: −39° C.; volume-average particle diameter: 140 nm; solid content: 45% by mass; manufactured by DKS Co. Ltd.)
SUPERFLEX 740 (Tg: −34° C.; volume-average particle diameter: 200 nm; solid content: 40% by mass; manufactured by DKS Co. Ltd.)
TAKELAC WS-6021 (Tg: −60° C.; volume-average particle diameter: 90 nm; solid content: 30% by mass; manufactured by Mitsui Chemicals, Inc.)
TAKELAC W-6110 (Tg: −20° C.; volume-average particle diameter: 90 nm; solid content: 32% by mass; manufactured by Mitsui Chemicals, Inc.)
SUPERFLEX 130 (Tg: 101° C.; volume-average particle diameter: 30 nm; manufactured by DKS Co. Ltd.)
SUPERFLEX 170 (Tg: 75° C.; volume-average particle diameter: 10 nm; solid content: 33% by mass; manufactured by DKS Co. Ltd.)
SUPERFLEX 830HS (Tg: 68° C.; volume-average particle diameter: 10 nm; solid content: 27% by mass; manufactured by DKS Co. Ltd.)
SUPERFLEX 870 (Tg: 78° C.; volume-average particle diameter: 30 nm; solid content: 30% by mass; manufactured by DKS Co. Ltd.)
TAKELAC W-5030 (Tg: 85° C.; volume-average particle diameter: 50 nm; manufactured by Mitsui Chemicals, Inc.)
TAKELAC W-5661 (Tg: 70° C.; volume-average particle diameter: 30 nm; solid content: 35% by mass; manufactured by Mitsui Chemicals, Inc.)
TAKELAC WS-5984 (Tg: 70° C.; volume-average particle diameter: 80 nm; manufactured by Mitsui Chemicals, Inc.)
TAKELAC W-6010 (Tg: 90° C.; volume-average particle diameter: 60 nm; manufactured by Mitsui Chemicals, Inc.)
TAKELAC W-6020 (Tg: 90° C.; volume-average particle diameter: 80 nm; solid content: 30% by mass; manufactured by Mitsui Chemicals, Inc.)
TAKELAC W-605 (Tg: 100° C.; volume-average particle diameter: 80 nm; manufactured by Mitsui Chemicals, Inc.)
TAKELAC W-635 (Tg: 70° C.; volume-average particle diameter: 150 nm; manufactured by Mitsui Chemicals, Inc.)

It should be noted that U-COAT, PERMARIN, UPRENE, SUPERFLEX, and TAKELAC are registered trademarks.

The glass transition temperature (Tg) of the resin can be measured, for example, using DSC-60A Plus equipped with a cooling system, manufactured by Shimadzu Corp.

When the ink according to an embodiment of the present invention is formed into a dried ink film, multiple glass transition temperatures may be detected. Among these, one of the glass transition temperatures is preferably 70° C. or higher from the viewpoint of fixability.

Further, it is more preferably 95° C. or lower from the viewpoint of rubbing resistance. Another glass transition temperature need not be 70° C. or higher, but is preferably-40° C. or higher from the viewpoint of fixability and room temperature or lower from the viewpoint of rubbing resistance.

The particle size of the solid components in the ink is not particularly limited and can be appropriately selected depending on the purpose. However, from the viewpoints of improving ejection stability and image quality such as image density, the maximum frequency particle size of the solid components in the ink, expressed in terms of the number of particles, is preferably 20 nm or more and 1,000 nm or less, more preferably 20 nm or more and 150 nm or less. The solid components include the resin particles, the pigment particles, and the like. The particle size can be measured using a particle size analyzer (Nanotrac Wave II-UT151, manufactured by MicrotracBEL Corp.).

### <Additive>

The ink may include, as needed, a surfactant, a defoaming agent, a preservative/antifungal agent, a rust inhibitor, a pH adjuster, or the like.

### <Surfactant>

As the surfactant, any of a silicone-based surfactant, a fluorine-based surfactant, an acetylene glycol-based surfactant, an amphoteric surfactant, a nonionic surfactant, and an anionic surfactant can be used.

The silicone-based surfactant is not particularly limited and can be appropriately selected depending on the purpose.

Among these, those that do not decompose under high pH conditions are preferable. Examples thereof include, but are not limited to, a side-chain-modified polydimethylsiloxane, a both-end-modified polydimethylsiloxane, a single-end-modified polydimethylsiloxane, and a side-chain/both-end-modified polydimethylsiloxane. In particular, those having a polyoxyethylene group or a polyoxyethylene polyoxypropylene group as a modifying group are preferable, since they exhibit good properties as aqueous surfactants. Further, a polyether-modified silicone-based surfactant can also be used as the silicone-based surfactant. Examples thereof include, but are not limited to, a compound in which a polyalkylene oxide structure is introduced into the Si side chain of dimethylsiloxane.

As the fluorine-based surfactant, for example, a perfluoroalkylsulfonic acid compound, a perfluoroalkylcarboxylic acid compound, a perfluoroalkylphosphate ester compound, a perfluoroalkylethylene oxide adduct, and a polyoxyalkylene ether polymer compound having a perfluoroalkyl ether group in a side chain are particularly preferable because they exhibit low foaming properties. Examples of the perfluoroalkylsulfonic acid compound include, but are not limited to, a perfluoroalkylsulfonic acid and a perfluoroalkylsulfonic acid salt. Examples of the perfluoroalkylcarboxylic acid compound include, but are not limited to, a perfluoroalkylcarboxylic acid and a perfluoroalkylcarboxylic acid salt. Examples of the polyoxyalkylene ether polymer compound having a perfluoroalkyl ether group in a side chain include, but are not limited to, a sulfate ester salt of polyoxyalkylene ether polymer having a perfluoroalkyl ether group in a side chain and a salt of polyoxyalkylene ether polymer having a perfluoroalkyl ether group in a side chain. Examples of a counter ion for the salts in these fluorine-based surfactants include, but are not limited to, Li, Na, K, NH₄, NH₃CH₂CH₂OH, NH₂(CH₂CH₂OH)₂, and NH(CH₂CH₂OH)₃.

As the acetylene glycol-based surfactant, a nonionic surfactant having a symmetrical structure with an acetylene group at the center can be mentioned. Such a surfactant serves as a “low-foaming wetting agent” and is environmentally friendly.

Examples of the amphoteric surfactant include, but are not limited to, a laurylamino propionic acid salt, lauryldimethylbetaine, stearyldimethylbetaine, and lauryldihydroxyethylbetaine.

Examples of the nonionic surfactant include, but are not limited to, a polyoxyethylene alkylphenyl ether, a polyoxyethylene alkyl ester, a polyoxyethylene alkylamine, a polyoxyethylene alkylamide, a polyoxyethylene-polypropylene block polymer, a sorbitan fatty acid ester, a polyoxyethylene sorbitan fatty acid ester, and an ethylene oxide adduct of acetylenic alcohol.

Examples of the anionic surfactant include, but are not limited to, a polyoxyethylene alkyl ether acetic acid salt, a dodecylbenzenesulfonic acid salt, a lauric acid salt, and a salt of polyoxyethylene alkyl ether sulfuric acid.

These may be used alone or in combination of two or more types.

The silicone-based surfactant is not particularly limited and can be appropriately selected depending on the purpose. Examples thereof include, but are not limited to, a side-chain-modified polydimethylsiloxane, a both-end-modified polydimethylsiloxane, a single-end-modified polydimethylsiloxane, and a side-chain/both-end-modified polydimethylsiloxane. Among these, a polyether-modified silicone-based surfactant having a polyoxyethylene group or a polyoxyethylene polyoxypropylene group as a modifying group is particularly preferable since it exhibits good properties as an aqueous surfactant.

Such surfactants may be appropriately synthesized or commercially available products. Examples of the commercially available products include, but are not limited to, those obtainable from BYK Japan KK, Shin-Etsu Chemical Co., Ltd, Dow Toray Co., Ltd., Nihon Emulsion Co., Ltd., and Kyoeisha Chemical Co., Ltd.

The polyether-modified silicone-based surfactant is not particularly limited and can be appropriately selected depending on the purpose. Examples thereof include, but are not limited to, a compound represented by the general formula (S-1) in which a polyalkylene oxide structure is introduced into the Si side chain of dimethylpolysiloxane.

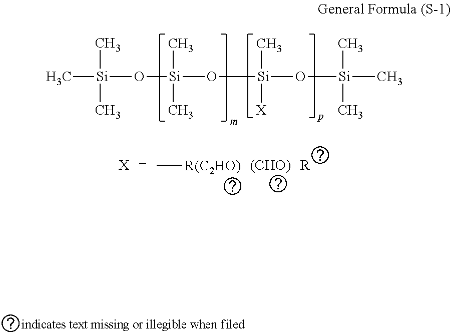

(In the general formula (S-1), m, n, a, and b each independently represent an integer, R represents an alkylene group, and R′ represents an alkyl group.)

As the polyether-modified silicone-based surfactant, a commercially available product can be used. Examples thereof include, but are not limited to, KF-353, KF-640, KF-642, KF-643, and KF-644 (manufactured by Shin-Etsu Chemical Co., Ltd.,); EMALEX-SS-5051 (manufactured by Nihon Emulsion Co., Ltd.); BYK-345, BYK-347, BYK-348, BYK-375, and BYK-377 (manufactured by BYK Japan KK); SILFACE SAG002, SILFACE SAG003, SILFACE SAG005, SILFACE SAG503A, and SILFACE SAG008 (manufactured by Nissin Chemical Co., Ltd.); and TEGO_Wet_KL245, TEGO_Wet_250, TEGO_Wet_260, TEGO_Wet_265, TEGO_Wet_270, and TEGO_Wet_280 (manufactured by Evonik Japan Co., Ltd.).

As the fluorine-based surfactant, a compound having 2 to 16 fluorine-substituted carbon atoms is preferable, and a compound having 4 to 16 fluorine-substituted carbon atoms is more preferable.

Examples of the fluorine-based surfactant include, but are not limited to, a perfluoroalkyl phosphate ester compound, a perfluoroalkylethylene oxide adduct, and a polyoxyalkylene ether polymer compound having a perfluoroalkyl ether group in a side chain. Among these, a polyoxyalkylene ether polymer compound having a perfluoroalkyl ether group in a side chain is preferable because of their low foaming properties, and in particular, fluorine-based surfactants represented by general formulas (F-1) and (F-2) are preferable.

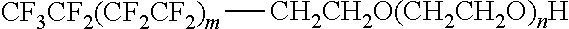

In the compound represented by the general formula (F-1), it is preferable that m is an integer of 0 to 10, and n is an integer of 0 to 40 for imparting water solubility to the compound.

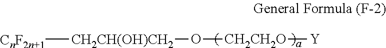

In the compound represented by the general formula (F-2), Y is H, CₘF₂ₘ₊₁ where m is an integer of 1 to 6, CH₂CH(OH)CH₂—CₘF₂ₘ₊₁ where m is an integer of 4 to 6, or CₚH₂ₚ₊₁ where p is an integer of 1 to 19, n is an integer of 1 to 6, and a is an integer of 4 to 14.

A commercially available product may be used as the fluorine-based surfactant. Examples of the commercially available product include, but are not limited to, SURFLON S-242, S-243, S-420, and S-431 (each manufactured by AGC Seimi Chemical Co., Ltd.); MEGAFACE F-251, F-430, F-444, F-477, F-552, F-553, and F-554 (each manufactured by DIC Corp.); CAPSTONE FS-10, FS-30, FS-31, FS-34, FS-35, FS-51, FS-60, FS-61, FS-63, FS-64, FS-65, and FS-3100 (each manufactured by DuPont); FTERGENT 212M, FTERGENT 215M, FTERGENT 250, FTERGENT 251, FTERGENT 222F, and FTERGENT 245F (each manufactured by NEOS Company Ltd.); and POLYFOX PF-136A, PF-156A, and PF-151N (manufactured by Kitamura Chemicals Co., Ltd.). Among these, CAPSTONE FS-3100 and CAPSTONE FS-34, manufactured by Chemours Company, FTERGENT 250 and FTERGENT 251, manufactured by NEOS Company Ltd., and POLYFOX PF-151N, manufactured by Kitamura Chemicals Co., Ltd., are particularly preferable because they provide good printing quality, especially with significantly improved color developability, ink penetration into paper, wettability, and uniform spreadability.

Commercially available products can be used as the acetylene glycol surfactant and the acetylene alcohol surfactant. Examples thereof include, but are not limited to, SURFYNOL 104E, SURFYNOL 420, SURFYNOL 440, SURFYNOL 465, SURFYNOL SE, SURFYNOL SE-F, SURFYNOL PSA-336, SURFYNOL DF110D, and SURFYNOL DF58, as well as OLFINE E1004, OLFINE E1010, OLFINE E1020, OLFINE PD-001, OLFINE PD-002W, OLFINE PD-004, OLFINE PD-005, OLFINE EXP.4001, OLFINE EXP.4200, OLFINE EXP.4123, and OLFINE EXP.4300 (each manufactured by Nissin Chemical Co., Ltd.).

The content of the surfactant in the ink is not particularly limited and can be appropriately selected depending on the purpose. From the viewpoints of providing excellent wettability and ejection stability and improving image quality, the surfactant content is preferably 0.001% by mass or more and 5% by mass or less, more preferably 0.05% by mass or more and 5% by mass or less.

### <Defoaming Agent>>

The defoaming agent is not particularly limited, and examples thereof include, but are not limited to, a silicone-based defoaming agent, a polyether-based defoaming agent, and a fatty acid ester-based defoaming agent. These may be used alone or in combination of two or more types. Among them, a silicone-based defoaming agent is preferable because of its excellent defoaming effects.

### <<Preservative/Antifungal Agent>>

The preservative/antifungal agent is not particularly limited, and examples thereof include, but are not limited to, 1,2-benzisothiazolin-3-one.

### <<Rust Inhibitor>>

The rust inhibitor is not particularly limited, and examples thereof include, but are not limited to, an acid sulfite and sodium thiosulfate.

### <<pH Adjuster>>

The pH adjuster is not particularly limited as long as it can adjust the pH to 7 or higher. Examples thereof include, but are not limited to, an amine such as diethanolamine and triethanolamine.

### <Ink Physical Properties>

The physical properties of the ink are not particularly limited and can be appropriately selected depending on the purpose. For example, it is preferable that the viscosity, the surface tension, and the like fall within the ranges described below.

The viscosity of the ink at 25° C. is preferably 3 mPa's to 15 mPa's, more preferably in the range of 5 mPa's to 10 mPa's at 25° C. When the viscosity of the ink is 5 mPa's or more, the printing density and character quality can be improved. On the other hand, maintaining the ink viscosity at 10 mPa's or less ensures good ejection properties.

The viscosity described herein can be measured at 25° C., for example, using a viscometer (RE-85L, manufactured by Tokisangyo).

### <Contact Angle of Organic Solvent on Dried Ink Film>

A method for forming the dried ink film is not limited, as long as the ink can be uniformly applied. Examples of the method include, but are not limited to, a method of printing a solid image on a PET film and drying it for several minutes in an oven at around 100° C., and a method of applying the ink onto a PET film using a bar coater and drying it in the same manner.

The contact angle can be measured, for example, using a DMo-501 (manufactured by Kyowa Interface Science Co., Ltd.). Under an environment at 25° C., a syringe filled with the organic solvent A or the organic solvent B is set in the device, and a droplet of 2 μL is formed using a needle having a thickness of 0.7 mm. The moment the droplet contacts the dried ink film is defined as 0 s, and the static contact angle is measured every 100 ms thereafter. When the contact angle is measured up to 5000 ms, the contact angle at 1000 ms is taken as the contact angle of interest.

In the ink according to an embodiment of the present invention, the contact angle of the organic solvent A on the dried ink film is smaller than that of the organic solvent B, and the difference in contact angle at 1000 ms therebetween is 5° or more.

### <Recording Medium>

The recording medium used for recording is not particularly limited, and examples thereof include, but are not limited to, plain paper, glossy paper, specialty paper, a fabric, a film, an OHP sheet, and general-purpose printing paper.

Among these, general-purpose printing paper having ink absorption properties within a certain range is preferable, since it can record an image with excellent image quality (image density, color saturation, beading, and color bleeding), high glossiness, and excellent smear fixing performance.

As such general-purpose printing paper having ink absorption properties within a certain range, a commercially available product can be used. Examples thereof include, but are not limited to, POD GLOSS COAT, OK TOP COAT+, OK KINFUJI+, and SA KINFUJI+ (manufactured by Oji Paper Co., Ltd.); SUPER MI DULL, AURORA COAT, and SPACE DX (manufactured by Nippon Paper Industries Co., Ltd.); α MATTE, and μ COAT (manufactured by Hokuetsu Corp.); RAICHO ART and RAICHO SUPER ART (manufactured by Chuetsu Pulp & Paper Co., Ltd.); and PEARL COAT N (manufactured by Mitsubishi Paper Mills Ltd.).

### <Recorded Matter>

An ink recorded matter according to an embodiment of the present invention is an image formed on a recording medium using the ink according to an embodiment of the present invention.

The recorded matter can be produced by recording using an inkjet recording apparatus and an inkjet recording method.

### <Recording Apparatus and Recording Method>

The ink according to an embodiment of the present invention can be suitably used in various inkjet recording apparatuses, such as, for example, a printer, a facsimile machine, a copier, a printer/fax/copier multifunction machine, and a three-dimensional modeling apparatus.

In the present disclosure, the recording apparatus and the recording method refer to an apparatus capable of ejecting ink or various processing liquids onto a recording medium, and a method for recording using such an apparatus. The term recording medium refers to a medium on which the ink or various processing liquids can temporarily or permanently adhere.

The recording apparatus can include not only a head portion that ejects the ink, but also various means related to feeding, conveying, and discharging the recording medium, as well as various devices such as a pre-treatment device and a post-treatment device.

The recording apparatus and the recording method may include a heating means used in a heating step and a drying means used in a drying step. The heating means and the drying means include, for example, a means for heating and drying the printed surface or the reverse side of the recording medium. The heating means and the drying means are not particularly limited. However, examples thereof that can be used include a hot-air heater and an infrared heater. The heating and drying can be performed before, during, or after printing.

Further, the recording apparatus and the recording method are not limited to those by which meaningful images such as characters or figures are visualized with the ink. For example, they also include an apparatus and method that form a pattern or the like, such as a geometric design, or that create a three-dimensional object.

Further, unless otherwise specified, the recording apparatus includes both a serial-type apparatus, in which the ejection head is moved, and a line-type apparatus, in which the ejection head remains stationary.

Further, the recording apparatus includes not only a desktop-type apparatus, but also a wide-format recording apparatus capable of printing on a recording medium of A0 size, as well as a continuous-feed printer capable of using continuous paper wound into a roll, for example, as a recording medium.

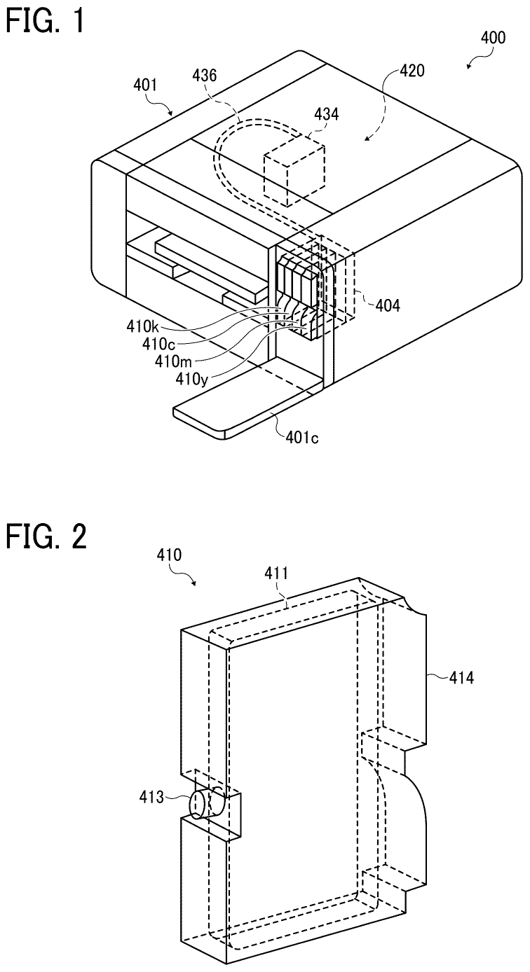

An example of the recording apparatus is described with reference to FIG. 1 and FIG. 2. FIG. 1 is a perspective view of a recording apparatus, and FIG. 2 is a perspective view of a main tank. An example of the recording apparatus, namely an image forming apparatus 400 is a serial-type image forming apparatus. A mechanism unit 420 is provided inside an outer casing 401 of the image forming apparatus 400. For example, each main tank 410 (410k, 410c, 410m, 410y) for color of black (K), cyan (C), magenta (M), or yellow (Y) includes an ink storage unit 411 formed by, for example, a packaging member such as an aluminum-laminate film. The ink storage unit 411 is accommodated, for example, in a storage container case 414 made of plastic. In this manner, the main tank 410 is used as an ink cartridge for each color. It should be noted that the color ink is not limited to black (K), cyan (C), magenta (M), and yellow (Y), and may also include other colors such as white and metallic ink.

The same applies to the main tank 410 for each color and each ink storage unit 411.

On the other hand, a cartridge holder 404 is provided at the rear side of the opening when a cover 401c of the apparatus main body is opened. The main tank 410 is detachably mounted on the cartridge holder 404. In this manner, an ink ejection port 413 of the main tank 410 communicates with an ejection head 434 for each color through a supply tube 436 for each color, making it possible to eject the ink from the ejection head 434 onto a recording medium. Further, the main tank 410 for each color or each ink storage unit 411 may be filled with a pre-treatment liquid or a post-treatment liquid instead of the ink, and the liquid may be ejected from the ejection head 434 onto a recording medium.

The recording apparatus can include not only a portion that ejects the ink but also other devices, such as a pre-treatment device and a post-treatment device.

As one aspect of the pre-treatment device and the post-treatment device, a configuration may be employed in which, similarly to the case of the ink such as black (K), cyan (C), magenta (M), or yellow (Y), a liquid storage unit including the pre-treatment liquid or the post-treatment liquid and a liquid ejection head are additionally provided, and the pre-treatment liquid or the post-treatment liquid is ejected by the inkjet recording method.

As another aspect of the pre-treatment device and post-treatment device, a configuration may be employed in which the pre-treatment device or the post-treatment device is provided that uses a method other than the inkjet recording method, such as a blade coating method, a roll coating method, or a spray coating method.

It should be noted that the ink can be used in a wide variety of methods, without being limited to the inkjet recording method. Examples of the method other than the inkjet recording method include, but are not limited to, a blade coating method, a gravure coating method, a bar coating method, a roll coating method, a dip coating method, a curtain coating method, a slide coating method, a die coating method, and a spray coating method.

The applications of the ink according to an embodiment of the present invention are not particularly limited and can be appropriately selected depending on the purpose. For example, the ink can be applied to a printed matter, a paint, a coating material, a primer, and the like. Further, the ink can be used not only for forming a two-dimensional character or image, but also as a material for three-dimensional modeling to form a three-dimensional object (three-dimensional molded article).

A three-dimensional modeling apparatus for molding the three-dimensional modeled article may be any known apparatus and is not particularly limited. For example, an apparatus equipped with an ink storage means, an ink supply means, an ink ejection means, an ink drying means, and the like can be used. The term three-dimensional modeled article includes the one obtained by applying the ink in layers. It also includes a mold-processed product obtained by processing a structural body formed by applying the ink onto a substrate such as a recording medium. The mold-processed product is formed, for example, by subjecting a recorded matter or structural body formed into a sheet or film shape to a molding process such as thermal stretching or punching. Such a mold-processed product is suitably used in applications where the surface is to be molded after decoration, such as panels for meters and operation units of automobiles, office automation equipment, electrical and electronic devices, and cameras.

Further, in the present disclosure, the terms “image formation”, “recording”, “printing” and the like are used synonymously.

The terms “recording medium”, “medium”, and “printing material” are used synonymously.

Unless otherwise specified, the preparation and evaluation of the ink were carried out under conditions of 25° C. and 60% humidity.

As qualitative and quantitative methods for the organic solvents, resins, colorants, and other components included in the ink, for example, a method such as gas chromatography-mass spectrometry (GC-MS) can be mentioned. Examples of a measuring instrument for the gas chromatography-mass spectrometry (GC-MS) include, but are not limited to, GCMS-QP2020NX (manufactured by Shimadzu Corp.). Further, the water included in the ink can be measured by a general method such as quantification of volatile components by the gas chromatography-mass spectrometry (GC-MS) or mass fluctuation measurement by thermogravimetry-differential thermal analysis (TG-DTA).

### EXAMPLES

Embodiments of the present invention are described in more detail below with reference to Examples and Comparative examples. However, embodiments of the invention are not limited to these examples. In the following description, the term “part(s)” refers to parts by mass, and the symbol “%” refers to mass percent.

### Preparation Example 1: Preparation of Black Pigment Dispersion Liquid

A carbon black in an amount of 90 g having a CTAB specific surface area of 150 m²/g and a DBP oil absorption of 100 mL/100 g was added to 3,000 mL of a 2.5 N sodium sulfate solution. The mixture was stirred at a speed of 300 rpm at a temperature of 60° C. to perform an oxidation treatment reaction for 10 hours. The resulting reaction liquid was filtered, and the filtered carbon black was neutralized with a sodium hydroxide solution and then subjected to ultrafiltration. The obtained carbon black was washed with water and dried, and subsequently dispersed in pure water so that the pigment concentration became 15% by mass. In this manner, a black pigment dispersion liquid of Preparation example 1 was prepared.

### Preparation Example 2: Preparation of Yellow Pigment Dispersion Liquid

A yellow pigment was prepared by introducing carboxylic acid groups into a yellow pigment C.I. Pigment Yellow 128 through a low-temperature plasma treatment. The treated yellow pigment was dispersed in deionized water, and the dispersion was desalted and concentrated using an ultrafiltration membrane to obtain a yellow pigment dispersion liquid of Preparation example 2, with a pigment concentration of 15% by mass.

### Preparation Example 3: Preparation of Magenta Pigment Dispersion Liquid

Except that C.I. Pigment Red 122 was used in place of C.I. Pigment Yellow 128, a surface-modified magenta pigment was prepared in the same manner as in Preparation example 2. The resulting pigment was dispersed in deionized water, and the dispersion was desalted and concentrated using an ultrafiltration membrane to obtain a magenta pigment dispersion liquid of Preparation example 3, with a pigment concentration of 15% by mass.

### Preparation Example 4: Preparation of Cyan Pigment Dispersion Liquid

Except that C.I. Pigment Blue 15:3 was used in place of C.I. Pigment Yellow 128, a surface-modified cyan pigment was prepared in the same manner as in Preparation example 2. The resulting pigment was dispersed in deionized water, and the dispersion was desalted and concentrated using an ultrafiltration membrane to obtain a cyan pigment dispersion liquid of Preparation example 4, with a pigment concentration of 15% by mass.

### Preparation Example 5: Preparation of Urethane Resin Emulsion

In a four-necked flask equipped with a stirrer, a reflux condenser, a thermometer, and a nitrogen inlet tube, 1,500 parts by mass of a polycarbonate diol (a reaction product of 1,6-hexanediol and dimethyl carbonate; number-average molecular weight (Mn): 1,600), 220 parts by mass of 2,2-dimethylolpropionic acid, and 1,347 parts by mass of N-methylpyrrolidone were charged under a nitrogen atmosphere and heated to 60° C. to dissolve the 2,2-dimethylolpropionic acid.

Next, 1,445 parts by mass of dicyclohexylmethane 4,4′-diisocyanate and 2.6 parts by mass of dibutyltin dilaurate (catalyst) were added, and the mixture was heated to 90° C. and reacted for 5 hours to obtain an isocyanate-terminated urethane prepolymer. The reaction mixture was then cooled to 80° C., and 149 parts by mass of triethylamine were added and mixed. From this mixture, 4,340 g were taken out and added into a mixed solution of 5,400 parts by mass of water and 15 parts by mass of triethylamine under vigorous stirring.

Subsequently, 1,500 parts by mass of ice were added, and then 626 parts by mass of a 35% by mass aqueous solution of 2-methyl-1,5-pentanediamine were added to perform a chain extension reaction. The solvent was then distilled off so that the solid content concentration became 40% by mass, thereby obtaining a polycarbonate urethane resin emulsion 1.

### <Measurement of Glass Transition Temperature>

The glass transition temperature (Tg) of the obtained polycarbonate urethane resin emulsion 1 was measured using a differential scanning calorimeter (DSC) (Q2000 manufactured by TA Instruments).

The polycarbonate urethane resin emulsion 1 in an amount of 3 g was placed in a container so that it was evenly spread, dried at 50° C. for 24 hours, and then further dried at 100° C. for 5 hours to obtain a solid product as a measurement sample.

The glass transition temperature of the measurement sample was measured under the following conditions using the differential scanning calorimeter.

### (Measurement Conditions)

Sample container: aluminum sample pan (with lid)
Sample amount: 5 mg
Reference: aluminum sample pan (empty)
Atmosphere: nitrogen (flow rate: 50 mL/min)
Starting temperature: −20° C.
Heating rate: 10° C./min
End temperature: 150° C.
Hold time: 1 min
Cooling rate: 5° C./min
End temperature: −50° C.
Hold time: 5 min
Heating rate: 10° C./min
End temperature: 150° C.

Measurements were carried out under the above measurement conditions, and a graph of “heat flow” versus “temperature” was created.

The characteristic inflection point observed during the second heating process was taken as the glass transition temperature (Tg). Note that Tg was determined by the midpoint method from the DSC curve. Tg of the polycarbonate urethane resin emulsion 1 was −30° C.

### (Ink Preparation)

The ink was prepared by mixing and stirring the materials according to the formulation and blending amounts (% by mass) presented in Tables 2 to 4, followed by filtration through a 0.8 μm filter (manufactured by Sartorius AG, MINISART).

The details of the materials used are as follows. The details of the solvents are presented in Table 1.
SURFYNOL 465 (manufactured by Nissin Chemical Co., Ltd., surfactant)
PROXEL LV (manufactured by Nitto Avecia, preservative)·
AD01 (EnviroGem AD01, manufactured by Air Products and Chemicals, Inc., defoaming agent)·
2-Amino-2-ethyl-1,3-propanediol (pH adjuster)
Acrylic resin A: HIROS-X JE-1056 (Tg: 82° C., manufactured by Chemipaz Corp.)
Acrylic resin B: HIROS-X KE-1062 (Tg: 96° C., manufactured by Chemipaz Corp.)
Acrylic resin C: HIROS-X QE-1042 (Tg: 53° C., manufactured by Chemipaz Corp.)

Further, the contact-angle difference and the maximum value of the glass transition temperature (Tg) (i.e., the highest value among the detected Tg values) of the organic solvent A and the organic solvent B used in the resulting inks (Examples 1 to 24 and Comparative examples 1 to 10) are presented in Table 5.

TABLE 1

| | | | | SP values |
|---|---|---|---|---|
| | | | Boiling | (calculated |
| | No | Compounds | point | values) |
| Organic | 1 | Propylene glycol monomethyl ether | 120 | 10.2 |
| solvent | 2 | Propylene glycol monoethyl ether | 132 | 10.0 |
| A | 3 | Ethylene glycol monopropyl ether | 150 | 10.2 |
| | 4 | 1-Pentanol | 138 | 10.0 |
| | 5 | 1-Butanol | 118 | 10.2 |
| | 6 | 3-Methoxy-3-methyl-1-butanol | 174 | 9.6 |
| | 7 | Ethylene glycol monomethyl ether | 124 | 10.7 |
| | 8 | Propylene glycol monobutyl ether | 170 | 9.7 |
| Organic | 9 | 2,3-Butanediol | 183 | 12.5 |
| solvent | 10 | 1,2-Propanediol | 187 | 13.5 |
| B | 11 | 1,2-Butanediol | 194 | 12.8 |
| | 12 | 2-Methyl-2,4-pentanediol | 198 | 11.5 |
| | 13 | 3-Methyl-1,3-butanediol | 203 | 12.1 |
| | 14 | Diethylene glycol monomethylether | 193 | 10.3 |
| | 15 | Diethylene glycol ethyl monoethyl | 196 | 10.1 |
| | | ether | | |
| | 6 | 3-Methoxy-3-methyl-1-butanol | 174 | 9.6 |
| | 16 | 2-Methyl-1,3-propanediol | 213 | 12.8 |
| | 17 | 2-Ethylhexanol | 183.5 | 9.4 |

TABLE 2

| Examples | | 1 | 2 | 3 | 4 | 5 | 6 |
|---|---|---|---|---|---|---|---|
| Black | Preparation | 5 | — | — | — | — | — |
| pigment | example 1 | | | | | | |
| dispersion | | | | | | | |
| Yellow | Preparation | — | 3 | — | — | — | — |
| pigment | example 2 | | | | | | |
| dispersion | | | | | | | |
| Magenta | Preparation | — | — | 5 | — | 5 | 5 |
| pigment | example 3 | | | | | | |
| dispersion | | | | | | | |
| Cyan | Preparation | — | — | — | 3 | — | — |
| pigment | example 4 | | | | | | |
| dispersion | | | | | | | |
| Acrylic | A | 6 | 7.5 | 6 | 7.5 | 6 | 6 |
| resin | B | — | — | — | — | — | — |
| emulsion | C | — | — | — | — | — | — |
| Urethane | Preparation | 1 | 1.5 | 1 | 1.5 | 1 | 1 |
| resin | example 5 | | | | | | |
| emulsion | | | | | | | |
| Organic | 1 | 10 | 10 | 10 | 10 | — | 10 |
| solvent A | 2 | — | — | — | — | — | — |
| | 3 | — | — | — | — | — | — |
| | 4 | — | — | — | — | 10 | — |
| | 5 | — | — | — | — | — | — |
| | 6 | — | — | — | — | — | — |
| | 7 | — | — | — | — | — | — |
| | 8 | — | — | — | — | — | — |
| Organic | 9 | — | — | — | — | — | — |
| solvent B | 10 | 12 | 11.5 | 12 | 13 | 12 | — |
| | 11 | — | — | — | — | — | 11.5 |
| | 12 | — | — | — | — | — | — |
| | 13 | — | — | — | — | — | — |
| | 14 | — | — | — | — | — | — |
| | 15 | — | — | — | — | — | — |
| | 6 | — | — | — | — | — | — |
| | 16 | — | — | — | — | — | — |
| | 17 | — | — | — | — | — | — |
| Surfactant | SURFYNOL | 1 | 1 | 1 | 1 | 1 | 1 |
| | 465 | | | | | | |
| Water | | Rest | Rest | Res | Res | Rest | Rest |
| Total | | 100 | 100 | 100 | 100 | 100 | 100 |
| Examples | | 7 | 8 | 9 | 10 | 11 | 12 |
| Black | Preparation | — | — | — | — | — | — |
| pigment | example 1 | | | | | | |
| dispersion | | | | | | | |
| Yellow | Preparation | — | — | — | — | — | — |
| pigment | example 2 | | | | | | |
| dispersion | | | | | | | |
| Magenta | Preparation | 5 | 5 | 5 | 5 | 5 | 5 |
| pigment | example 3 | | | | | | |
| dispersion | | | | | | | |
| Cyan | Preparation | — | — | — | — | — | — |
| pigment | example 4 | | | | | | |
| dispersion | | | | | | | |
| Acrylic | A | 6 | 6 | 6 | 6 | 6 | 6 |
| resin | B | — | — | — | — | — | — |
| emulsion | C | — | — | — | — | — | — |
| Urethane | Preparation | 1 | 1 | 1 | 1 | 1 | 1 |
| resin | example 5 | | | | | | |
| emulsion | | | | | | | |
| Organic | 1 | — | 10 | 10 | 10.5 | 17 | 8 |
| solvent A | 2 | — | — | — | — | — | — |
| | 3 | — | — | — | — | — | — |
| | 4 | — | — | — | — | — | — |
| | 5 | — | — | — | — | — | — |
| | 6 | — | — | — | — | — | — |
| | 7 | — | — | — | — | — | — |
| | 8 | 12 | — | — | — | — | — |
| Organic | 9 | — | 11.5 | — | — | — | — |
| solvent B | 10 | — | — | — | 15.5 | 9 | 10 |
| | 11 | — | — | — | — | — | — |
| | 12 | — | — | — | — | — | — |
| | 13 | — | — | 11.5 | — | — | — |
| | 14 | 10 | — | — | — | — | — |
| | 15 | — | — | — | — | — | — |
| | 6 | — | — | — | — | — | — |
| | 16 | — | — | — | — | — | — |
| | 17 | — | — | — | — | — | — |
| Surfactant | SURFYNOL | 1 | 1 | 1 | 1 | 1 | 1 |
| | 465 | | | | | | |

| | | | | | | |
|---|---|---|---|---|---|---|
| Water | Rest | Rest | Rest | Rest | Rest | Rest |
| Total | 100 | 100 | 100 | 100 | 100 | 100 |

TABLE 3

| Examples | | 13 | 14 | 15 | 16 | 17 | 18 |
|---|---|---|---|---|---|---|---|
| Black | Preparation | — | — | — | — | — | — |
| pigment | example 1 | | | | | | |
| dispersion | | | | | | | |
| Yellow | Preparation | — | — | — | — | — | — |
| pigment | example 2 | | | | | | |
| dispersion | | | | | | | |
| Magenta | Preparation | 5 | 5 | 5 | 5 | 5 | 5 |
| pigment | example 3 | | | | | | |
| dispersion | | | | | | | |
| Cyan | Preparation | — | — | — | — | — | — |
| pigment | example 4 | | | | | | |
| dispersion | | | | | | | |
| Acrylic | A | 6 | 6 | 6 | 6 | 6.5 | 5 |
| resin | B | — | — | — | — | — | — |
| emulsion | C | — | — | — | — | — | — |
| Urethane | Preparation | 1 | 1 | 1 | 1 | 0.5 | 2 |
| resin | example 5 | | | | | | |
| emulsion | | | | | | | |
| Organic | 1 | 14 | 12 | 21 | — | 10 | 10 |
| solvent A | 2 | — | — | — | — | — | — |
| | 3 | — | — | — | — | — | — |
| | 4 | — | — | — | 10 | — | — |
| | 5 | — | — | — | — | — | — |
| | 6 | — | — | — | — | — | — |
| | 7 | — | — | — | — | — | — |
| | 8 | — | — | — | — | — | — |
| Organic | 9 | — | — | — | — | — | — |
| solvent B | 10 | 18 | 6 | 11 | — | 12 | 12 |
| | 11 | — | — | — | — | — | — |
| | 12 | — | — | — | — | — | — |
| | 13 | — | — | — | — | — | — |
| | 14 | — | — | — | 12 | — | — |
| | 15 | — | — | — | — | — | — |
| | 6 | — | — | — | — | — | — |
| | 16 | — | — | — | — | — | — |
| | 17 | — | — | — | — | — | — |
| Surfactant | SURFYNOL | 1 | 1 | 1 | 1 | 1 | 1 |
| | 465 | | | | | | |
| Water | | Rest | Rest | Rest | Rest | Rest | Rest |
| Total | | 100 | 100 | 100 | 100 | 100 | 100 |
| Examples | | 19 | 20 | 21 | 22 | 23 | 24 |
| Black | Preparation | — | — | — | — | — | — |
| pigment | example 1 | | | | | | |
| dispersion | | | | | | | |
| Yellow | Preparation | — | — | — | — | — | — |
| pigment | example 2 | | | | | | |
| dispersion | | | | | | | |
| Magenta | Preparation | 5 | 5 | 5 | 5 | 5 | 8 |
| pigment | example 3 | | | | | | |
| dispersion | | | | | | | |
| Cyan | Preparation | — | — | — | — | — | — |
| pigment | example 4 | | | | | | |
| dispersion | | | | | | | |
| Acrylic | A | 6.8 | 4.5 | — | — | 7 | 6 |
| resin | B | — | — | 6 | — | — | — |
| emulsion | C | — | — | — | 6 | — | — |
| Urethane | Preparation | 0.2 | 2.5 | 1 | 1 | 0 | 1 |
| resin | example 5 | | | | | | |
| emulsion | | | | | | | |
| Organic | 1 | 10 | 10 | 10 | 10 | 10 | 10 |
| solvent A | 2 | — | — | — | — | — | — |
| | 3 | — | — | — | — | — | — |
| | 4 | — | — | — | — | — | — |
| | 5 | — | — | — | — | — | — |
| | 6 | — | — | — | — | — | — |
| | 7 | — | — | — | — | — | — |
| | 8 | — | — | — | — | — | — |
| Organic | 9 | — | — | — | — | — | — |
| solvent B | 10 | 12 | 12 | 12 | 12 | 12 | 12 |
| | 11 | — | — | — | — | — | — |
| | 12 | — | — | — | — | — | — |
| | 13 | — | — | — | — | — | — |
| | 14 | — | — | — | — | — | — |
| | 15 | — | — | — | — | — | — |
| | 6 | — | — | — | — | — | — |
| | 16 | — | — | — | — | — | — |
| | 17 | — | — | — | — | — | — |
| Surfactant | SURFYNOL | 1 | 1 | 1 | 1 | 1 | 1 |
| | 465 | | | | | | |

| | | | | | | |
|---|---|---|---|---|---|---|
| Water | Res | Rest | Rest | Rest | Rest | Rest |
| Total | 100 | 100 | 100 | 100 | 100 | 100 |

TABLE 4

| Comparative examples | | 1 | 2 | 3 | 4 | 5 | 6 | 7 | 8 | 9 | 10 |
|---|---|---|---|---|---|---|---|---|---|---|---|
| Black | Preparation | — | — | — | — | — | — | — | — | — | — |
| pigment | example 1 | | | | | | | | | | |
| dispersion | | | | | | | | | | | |
| Yellow | Preparation | — | — | — | — | — | — | — | — | — | — |
| pigment | example 2 | | | | | | | | | | |
| dispersion | | | | | | | | | | | |
| Magenta | Preparation | 5 | 5 | 5 | 5 | 5 | 5 | 5 | 5 | 5 | 5 |
| pigment | example 3 | | | | | | | | | | |
| dispersion | | | | | | | | | | | |
| Cyan pigment | Preparation | — | — | — | — | — | — | — | — | — | — |
| dispersion | example 4 | | | | | | | | | | |
| Acrylic resin | A | 6 | 6 | 6 | 6 | 6 | 6 | 6 | 6 | 6 | — |
| emulsion | B | — | — | — | — | — | — | — | — | — | — |
| | C | — | — | — | — | — | — | — | — | — | — |
| Urethane resin | Preparation | 1 | 1 | 1 | 1 | 1 | 1 | 1 | 1 | 1 | 7 |
| emulsion | example 5 | | | | | | | | | | |
| Organic | 1 | — | — | 10 | 10 | 8 | 19 | 10 | — | 10 | 10 |
| solvent A | 2 | — | — | — | — | — | — | — | 10 | — | — |
| | 3 | — | — | — | — | — | — | — | — | — | — |
| | 4 | — | — | — | — | — | — | — | — | — | — |
| | 5 | 9 | — | — | — | — | — | — | — | — | — |
| | 6 | — | 11 | — | — | — | — | — | — | — | — |
| | 7 | — | — | — | — | — | — | — | — | — | — |
| | 8 | — | — | — | — | — | — | — | — | — | — |
| Organic | 9 | — | — | — | — | — | — | — | — | — | — |
| solvent B | 10 | 12 | 12 | — | — | 18 | 8 | — | — | — | 12 |
| | 11 | — | — | — | — | — | — | — | — | — | — |
| | 12 | — | — | — | — | — | — | — | — | — | — |
| | 13 | — | — | — | — | — | — | — | — | — | — |
| | 14 | — | — | — | — | — | — | — | 11.5 | — | — |
| | 15 | — | — | — | — | — | — | 11 | — | — | — |
| | 6 | — | — | 11 | — | — | — | — | — | — | — |
| | 16 | — | — | — | 12 | — | — | — | — | — | — |
| | 17 | — | — | — | — | — | — | — | — | 11 | — |
| Surfactant | SURFYNOL | 1 | 1 | 1 | 1 | 1 | 1 | 1 | 1 | 1 | 1 |
| | 465 | | | | | | | | | | |

| | | | | | | | | | | |
|---|---|---|---|---|---|---|---|---|---|---|
| Water | Rest | Rest | Rest | Rest | Rest | Rest | Rest | Rest | Rest | Rest |
| Total | 100 | 100 | 100 | 100 | 100 | 100 | 100 | 100 | 100 | 100 |

TABLE 5

| | Contact angle difference | |
|---|---|---|
| | on dried ink film | |
| | (organic solvent B − | Dried ink film |
| | organic solvent A) | maximum Tg |
| Example 1 | 13° | 80° C. |
| Example 2 | 13° | 81° C. |
| Example 3 | 13° | 80° C. |
| Example 4 | 13° | 81° C. |
| Example 5 | 14° | 80° C. |
| Example 6 | 12° | 80° C. |
| Example 7 | 7° | 80° C. |
| Example 8 | 12° | 80° C. |
| Example 9 | 12° | 80° C. |
| Example 10 | 13° | 80° C. |
| Example 11 | 13° | 80° C. |
| Example 12 | 13° | 80° C. |
| Example 13 | 13° | 80° C. |
| Example 14 | 13° | 80° C. |
| Example 15 | 13° | 80° C. |
| Example 16 | 5° | 80° C. |
| Example 17 | 13° | 80° C. |
| Example 18 | 13° | 80° C. |
| Example 19 | 13° | 81° C. |
| Example 20 | 13° | 79° C. |
| Example 21 | 15° | 92° C. |
| Example 22 | 10° | 52° C. |
| Example 23 | 13° | 80° C. |
| Example 24 | 13° | 80° C. |
| Comparative example 1 | 13° | 80° C. |
| Comparative example 2 | 15° | 80° C. |
| Comparative example 3 | −3° | 80° C. |
| Comparative example 4 | 12° | 80° C. |
| Comparative example 5 | 13° | 80° C. |
| Comparative example 6 | 13° | 80° C. |
| Comparative example 7 | 2° | 80° C. |
| Comparative example 8 | −1° | 80° C. |
| Comparative example 9 | −4° | 80° C. |
| Comparative example 10 | 9° | −27° C. |

### <Evaluation 1: Storage Stability>

Using E-550L (manufactured by Tokisangyo: cone 1°34′×R24), the viscosity of each ink was measured before storage and after storage in a sealed container at 70° C. for 10 days. Then, the storage stability of the ink was determined according to the following formula and evaluated based on the following criteria.

Storage stability=(viscosity after storage/viscosity before storage)×100

### [Evaluation Criteria]

A: 95% or more and 105% or less.
B: 90% or more and 95% or less, or greater than 105% and 110% or less.
C: 85% or more and 90% or less, or greater than 110% and 115% or less.
D: Less than 85%, or greater than 115%.

### —Image Formation—

Under environmental conditions adjusted to 23° C.±0.5° C. and 50±5% RH, image formation was carried out using an image forming apparatus (IPSiO GX e-5500, manufactured by Ricoh). The driving voltage of the piezoelectric element was changed so that the ink ejection amount became uniform, ensuring that the same amount of ink was deposited.

### <Evaluation 2: Ejection Stability>

A chart in which 5% of A4-sized paper area was filled with a solid image was printed continuously on 20 sheets of MyPaper (manufactured by Ricoh). After printing, the ejection irregularities of each nozzle were evaluated according to the criteria described below. As the print mode, the “Plain Paper-Standard Fast” mode was modified to “No Color Correction” in the plain paper user settings using the driver that came with the printer.

### [Evaluation Criteria]

A: No ejection irregularities.
B: Slight ejection irregularities.
C: Some ejection irregularities or some areas without ejection.
D: Severe ejection irregularities or a large number of nozzles without ejection.

### <Evaluation 3: Fixability (Rubbing Resistance)>

The recording medium was changed to OK TOP COAT+ (basis weight: 127.9 g/m²) manufactured by Oji Paper Co., Ltd, and the print mode used was modified from the “Glossy Paper-Fast” mode to “No Color Correction” using the driver that came with the printer. A solid image was printed in the same manner as for the image density evaluation. The print was dried for 15 seconds in a natural-convection drying oven with an internal temperature set to 100° C. One minute after drying, the solid image was set in a rubbing tester (product name: Crockmeter, manufactured by Toyo Seiki Seisaku-sho, Ltd.) and rubbed back and forth 10 times with filter paper. The stain density on a rubbed white paper side was measured using a portable spectrophotometer eXact™ manufactured by X-Rite, Inc., and evaluated according to the following evaluation criteria. Note that the stain density was a value excluding the background density of the recording medium.

### [Evaluation Criteria]

A: Less than 0.15.
B: 0.15 or more and less than 0.3.
C: 0.3 or more and less than 0.5.
D: 0.5 or more.

### <Evaluation 4: Fixability (Blocking)>

The recording medium was changed to OK TOPCOAT+ (basis weight 127.9 g/m²) manufactured by Oji Paper Co., Ltd., and the print mode used was modified from the “Glossy Paper-Fast” mode to “No Color Correction” using the printer driver that came with the printer. A solid image was printed in the same manner as for the image density evaluation. The print was dried for 10 seconds in a natural-convection drying oven with an internal temperature set to 100° C. The solid images were then overlaid and left for about 20 hours in an environment at 25° C. and 50% RH under a load of 5 kg/cm². After standing, the overlayed solid images were separated, and the transferred image was visually inspected and evaluated according to the following criteria.

### [Evaluation Criteria]

A: No transfer.
B: Transfer of fine dot image.
C: Slight image transfer.
D: Significant image transfer.

TABLE 6

| | | | Evaluation | |
|---|---|---|---|---|
| | Evaluation | Evaluation | 3 | Evaluation |
| | 1 | 2 | Fixability | 4 |
| | Storage | Ejection | (rubbing | Fixability |
| | stability | stability | resistance) | (blocking) |
| Example 1 | A | A | A | A |
| Example 2 | A | A | A | A |
| Example 3 | A | A | A | A |
| Example 4 | A | A | A | A |
| Example 5 | B | B | A | A |
| Example 6 | A | B | A | A |
| Example 7 | A | A | B | B |
| Example 8 | A | B | A | A |
| Example 9 | A | A | B | B |
| Example 10 | A | A | B | B |
| Example 11 | A | B | A | A |
| Example 12 | A | B | A | A |
| Example 13 | B | A | B | B |
| Example 14 | A | B | A | A |
| Example 15 | B | B | A | B |
| Example 16 | B | B | B | B |
| Example 17 | A | A | A | A |
| Example 18 | A | A | A | A |
| Example 19 | A | A | B | A |
| Example 20 | A | A | B | B |
| Example 21 | A | A | A | A |
| Example 22 | A | A | B | B |
| Example 23 | A | A | B | A |
| Example 24 | A | A | B | A |
| Comparative example 1 | B | C | A | A |
| Comparative example 2 | A | A | C | C |
| Comparative example 3 | C | D | A | A |
| Comparative example 4 | A | A | C | C |
| Comparative example 5 | A | A | D | D |
| Comparative example 6 | C | D | B | B |
| Comparative example 7 | C | B | D | D |
| Comparative example 8 | B | B | D | C |
| Comparative example 9 | C | C | D | D |
| Comparative example 10 | A | A | D | C |

Aspects of the present invention are as follows, for example.

### Aspect 1

An ink including a pigment, a resin, an organic solvent, and water, in which:
the organic solvent includes an organic solvent A having a boiling point of 120° C. or higher and 170° C. or lower, and an organic solvent B having a boiling point of 180° C. or higher and 210° C. or lower;
an SP value of the organic solvent B is greater than an SP value of the organic solvent A;
the content of the organic solvent A is 0.6 times or more and 2 times or less a content of the organic solvent B;
the contact angle of the organic solvent A on a dried ink film is less than a contact angle of the organic solvent B, and the difference in the contact angles between the two at 1000 ms is 5° or more; and
the resin includes an acrylic resin.

### Aspect 2

The ink according to the <Aspect 1>, in which the total content of the organic solvent A and the organic solvent B is 20% by mass or more and 40% by mass or less.

### Aspect 3

The ink according to the <Aspect 1> or <Aspect 2>, in which the organic solvent A is a glycol ether-based solvent, and the organic solvent B is an alkanediol-based solvent.

### Aspect 4

The ink according to any one of the <Aspect 1> to <Aspect 3>, in which the resin further includes a urethane resin and a content of the urethane resin is 0.05 times or more and 0.5 times or less a content of the acrylic resin.

### Aspect 5

The ink according to any one of the <Aspect 1> to <Aspect 4>, in which the dried ink film has a plurality of glass transition temperatures (Tg) and one of the Tg is 70° C. or higher.

### Aspect 6

The ink according to any one of the <Aspect 1> to <Aspect 5>, in which a content of the resin is greater than the total amount of the pigment.

### Aspect 7

An inkjet recording method including:
ejecting the ink according to any one of the <Aspect 1> to <Aspect 6> onto a recording medium to form an image; and
heating the recording medium.

The ink according to the <Aspect 1> to <Aspect 6> and the inkjet recording method according to the <Aspect 7> can solve the various conventional problems and achieve objects of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An ink comprising:
a pigment;
a resin including an acrylic resin;
an organic solvent including:
an organic solvent A having a boiling point of 120° C. or higher and 170° C. or lower; and
an organic solvent B having a boiling point of 180° C. or higher and 210° C. or lower; and
water,
wherein a solubility parameter value of the organic solvent B is greater than that of the organic solvent A,
a content of the organic solvent A is 0.6 times or more and 2 times or less that of the organic solvent B,
a contact angle of the organic solvent A on a dried film of the ink is less than that of the organic solvent B, and a difference therebetween at 1000 ms is 5° or more.

2. The ink according to claim 1, wherein a total content of the organic solvent A and the organic solvent B is 20% by mass or more and 40% by mass or less of the ink.

3. The ink according to claim 1, wherein the organic solvent A comprises a glycol ether-based solvent, and the organic solvent B comprises an alkanediol-based solvent.

4. The ink according to claim 1, wherein the resin further includes a urethane resin, and a content of the urethane resin is 0.05 times or more and 0.5 times or less that of the acrylic resin.

5. The ink according to claim 1, wherein the dried film of the ink has a plurality of glass transition temperatures, and one of the glass transition temperatures is 70° C. or higher.

6. The ink according to claim 1, wherein a content of the resin is greater than that of the pigment.

7. An inkjet recording method comprising:
ejecting the ink according to claim 1 onto a recording medium to form an image; and
heating the recording medium.
